(19) United States
(12) Patent Application Publication
(10) Pub. No.: US 2014/0129247 A1
(43) Pub. Date: May 8, 2014

(54) SYSTEM AND METHOD FOR PERFORMING PATIENT-SPECIFIC COST-EFFECTIVENESS ANALYSES FOR MEDICAL INTERVENTIONS

(71) Applicant: KONINKLIJKE PHILIPS N.V., EINDHOVEN (NL)

(72) Inventors: Jorn OP DEN BUIJS, EINDHOVEN (NL); Maartje Helena SCHONENBERG, EINDHOVEN (NL); Steffen Clarence PAUWS, EINDHOVEN (NL)

(73) Assignee: KONINKLIJKE PHILIPS N.V., EINDHOVEN (NL)

(21) Appl. No.: 14/070,618

(22) Filed: Nov. 4, 2013

Related U.S. Application Data
(60) Provisional application No. 61/722,941, filed on Nov. 6, 2012.

(51) Int. Cl. G06Q 50/22; G06Q 40/00

(52) U.S. Cl. CPC G06Q 50/22; G06Q 40/00
USPC 705/2

(57) ABSTRACT

A method for performing patient-specific cost-effectiveness analysis for medical interventions includes retrieving patient data associated with a patient, selecting one or more interventions based on the patient data, estimating at least one of health effects, resource consumption, and intervention costs for each of the selected interventions, calculating the net health benefit for each intervention, and displaying the net health benefit for each intervention.

### CROSS REFERENCE TO RELATED CASES

Applicants claim the benefit of Provisional Application Ser. No. 61/722,941, filed Nov. 6, 2012.

The present application relates generally to performing patient-specific cost-effectiveness analyses for medical interventions. It finds particular application in conjunction with selecting the most cost-effective intervention or treatment for a specific patient from multiple intervention and treatment programs applicable to that patient's clinical condition and will be described with particular reference thereto. However, it is to be understood that it also finds application in other usage scenarios and is not necessarily limited to the aforementioned application.

Healthcare in the western world is facing two difficult issues: rising costs and maintaining or improving quality of care. In the United States, a large portion of prescription medications, doctor visits, and procedures are often not based on the best available medical evidence, available from historical patient records. In certain cases this may lead to failure to provide a beneficial healthcare service. In other cases, the potential harm of provided healthcare services may actually exceed the expected benefits, and in some cases, provided care may indeed result in preventable complications (Consensus Statement—Sep. 16, 1998. The Urgent Need to Improve Health Care Quality, Institute of Medicine National Roundtable on Health Care Quality JAMA. 1998, 280:1000-1005). It has been estimated that over $300 billion dollars are wasted annually due to inefficient allocation of healthcare resources. To mitigate this problem, healthcare economics analyses are more and more often used to evaluate the benefits and financial consequences of healthcare interventions. These healthcare economic analyses can help medical professionals to make a decision about the treatment for a certain patient population based on the latest medical evidence available.

In healthcare economic analyses, the costs and the consequences of interventions expected to yield different outcomes are assessed. This can be achieved through cost-effectiveness analysis, whereby the costs are compared with outcomes measured in natural units such as life years gained, or pain or symptom free days gained. For example, a system and method for healthcare economic analysis of pharmaceutical interventions has been previously described in US 2007/0179809 A1. In this system, the healthcare economic analysis is performed based on the outcome (e.g., quality-adjusted life years) and costs (e.g., in US dollars) of the intervention for the case of the average person with a certain medical indication. For each intervention, the costs and benefits are then displayed to the user, such that an informed decision can be made.

A disadvantage of considering the average outcomes and costs of an intervention within a patient population is that outcomes and costs for persons with a certain medical indication can vary greatly from person to person. It is likely that healthcare economic analyses could be improved if the detailed medical records of the patients are taken into account to more accurately estimate expected outcomes and costs.

For example, two patients A and B could be diagnosed with the same medical indication, but experience a different severity of this condition (e.g., as indicated by a certain blood marker relevant to the disease progression). Let's assume that the clinical condition of patient A is less severe than the clinical condition of patient B. A cost-effectiveness analysis based on the average patient population with this medical indication would show that an intervention would result in the same costs and health outcomes for both patients, and thus, the intervention would appear to be equally cost-effective for both patients. Patient B would benefit from the intervention e.g., by gaining life years. However, patient A with the less severe condition may not require the intervention to achieve the same, or a very similar, health outcome as would be expected without the intervention. Furthermore, it is expected that patient A will consume less medical care than patient B over the next years. Whereas the intervention may result in healthcare cost-savings for patient B due to a reduction in further medical care consumption, this may not be the case for patient A. Thus, the intervention would result in “wasting” the costs for this intervention in case it is prescribed to patient A. In another scenario, where the intervention has certain side-effects, application of the intervention to patient A may even be harmful.

Disadvantages of current systems and methods for healthcare economic analysis are that they are based on average values of health outcomes and costs in patient populations. This renders them less accurate and therefore hampers their use in making decisions about the allocation of healthcare resources. As mentioned above, US 2007/0179809 A1 describes a system and method for healthcare economic analysis of pharmaceutical interventions. The method bases its calculations on the average person with a given medical indication. However, outcomes and costs can vary greatly within a patient group with a certain medical indication. This disadvantage seems to be acknowledged to some extent in US 2010/0125462 A1. It describes a system and method for cost-utility analysis for treatment of cancer. The analysis takes into account the information from a subgroup of patients with similar input parameters (age, tumor grade etc.) that have been subjected to a similar treatment protocol. The method uses classical statistical techniques to compute the expected outcomes (e.g., survival) from the historical information of the similar subgroup of patients. One disadvantage of such a method is that a very large database is needed to cover all the possible combinations of input parameters as to establish the different subgroups of similar patients. Further, the derived output parameters are still averages within patient populations, albeit patient populations that are more closely related to the current patient. The large patient database needs to be searched for a group of similar patients every time a new patient is considered. This hampers real-time implementation due to the many large queries.

A system and method for performing a healthcare-economic analysis based on the detailed medical record of a specific patient, whereby the intervention is closely tailored to the medical indication as well as the severity of the indication, could result in a much more efficient allocation of healthcare resources.

The present application solves mentioned disadvantages by incorporating advanced prediction models for the prediction of future health outcomes and costs based on the detailed medical records of a specific patient into the cost-effectiveness analyses. This is expected to result in much more accurate predictions of future costs and health outcomes of interventions. The prediction models can be readily implemented in a software application without the need for real-time querying of a large database to search for a cohort of similar patients. Furthermore, the algorithms underlying these prediction models can be formulated and updated on a regular basis in a secure offline environment, potentially reducing the risk for leaks of confidential information.

The present application provides new and improved methods and systems which overcome the above-referenced problems and others.

In accordance with one aspect, a method for performing patient-specific cost-effectiveness analysis for medical interventions is provided. The method including retrieving patient data associated with a patient, selecting one or more interventions based on the patient data, estimating at least one of health effects, resource consumption, and intervention costs for each of the selected interventions, calculating the net health benefit for each intervention, and displaying the net health benefit for each intervention.

In accordance with another aspect, a system for performing patient-specific cost-effectiveness analysis for medical interventions is provided. The system including one or more processors programmed to retrieve patient data associated with a patient, select one or more interventions based on the patient data, estimate at least one of health effects, resource consumption, and intervention costs for each of the selected interventions, calculate the net health benefit for each intervention, and display the net health benefit for each intervention.

In accordance with another aspect, a system for performing patient-specific cost-effectiveness analysis for medical interventions is provided. The system including a patient information system which stores patient data associated with a patient. A decision support system selects one or more interventions based on the patient data, estimate at least one of health effects, resource consumption, and intervention costs for each of the selected interventions, and calculate the net health benefit for each intervention. An interface system displays the net health benefit for each intervention.

One advantage resides in providing the cost-effectiveness of various treatment options to a specific patient.

Another advantage resides in incorporating advanced prediction models for the prediction of future health outcomes and costs.

Another advantage resides in improving patient care.

Still further advantages of the present invention will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

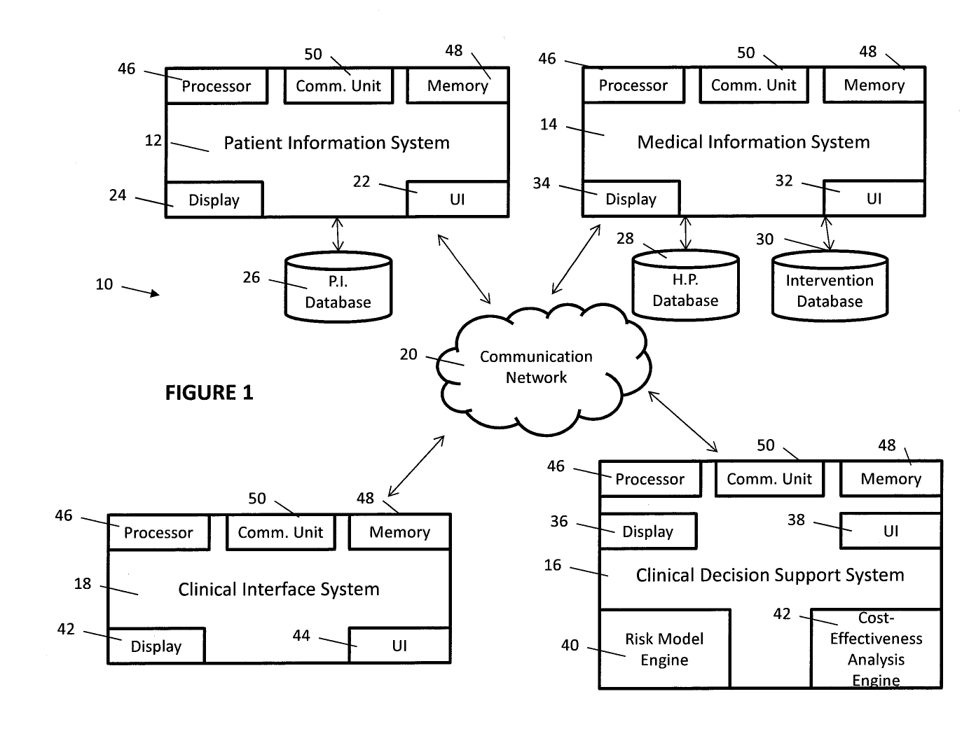

FIG. 1 illustrates a block diagram of an IT infrastructure according to aspects of the present application.

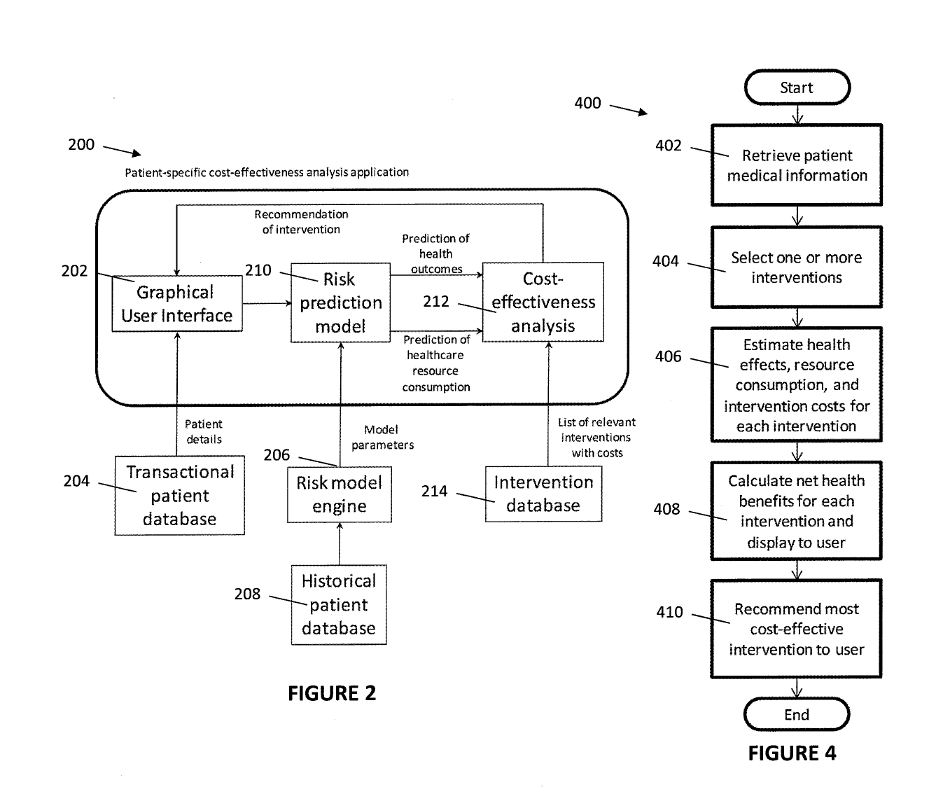

FIG. 2 illustrates a block diagram of a patient-specific cost-effectiveness analysis application according to aspects of the present application.

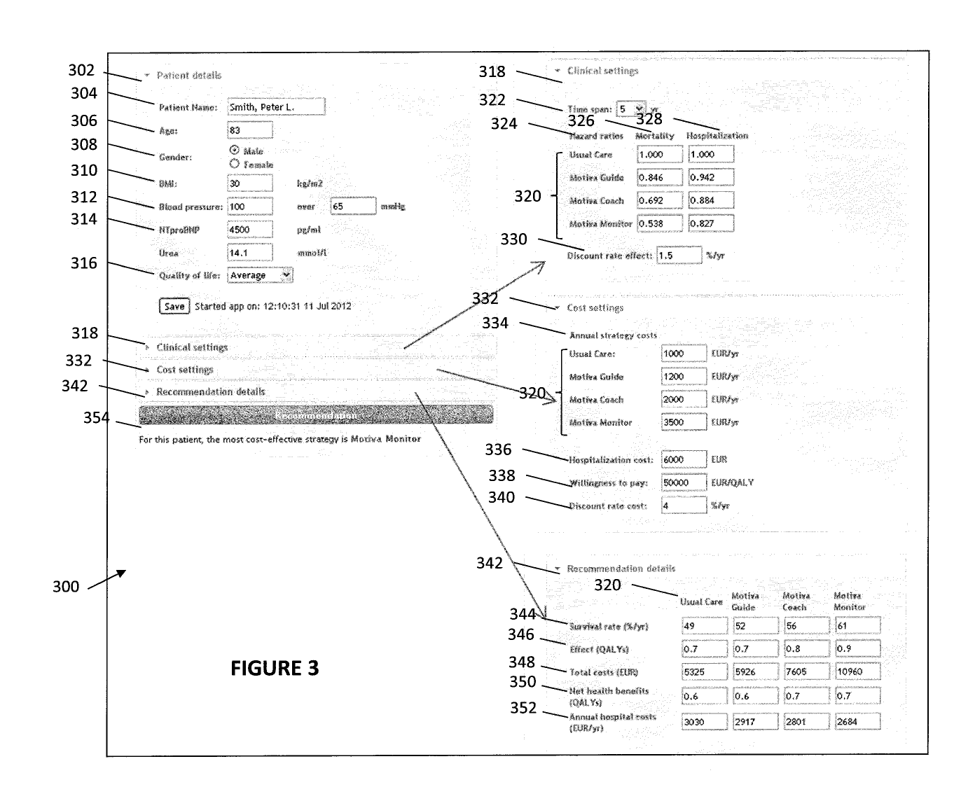

FIG. 3 illustrates an exemplary embodiment of a screenshot of a cost-effectiveness web-based application according to aspects of the present application.

FIG. 4 illustrates a flowchart diagram for performing a cost-effectiveness analysis according to aspects of the present application.

The present application is directed to a system and method for selecting the most cost-effective intervention or treatment for a specific patient from multiple interventions or treatment programs applicable to that patient's clinical condition utilizing detailed data from that specific patient's medical record. Specifically, the present application is directed to incorporating advanced prediction models (software implemented) that utilize algorithms for the prediction of future health outcomes and healthcare resource consumption based on the detailed medical record data of the specific patient. The parameters for the prediction model are obtained from a prediction model engine which generates the parameters by querying a historical patient database. (The historical patient database keeps records of the medical indication of patients, the interventions that were prescribed to them, their health outcomes and healthcare resource consumption.) The present application also incorporates a module for cost-effectiveness analysis, which receives predictions from the prediction model and estimates costs and effects of several interventions or treatments.

With reference to FIG. 1, a block diagram illustrates one embodiment of an IT infrastructure 10 of a medical institution, such as a hospital. The IT infrastructure 10 suitably includes a patient information system 12, a medical information system 14, a decision support system (DSS) 16, and a clinical interface system 18 and the like, interconnected via a communications network 20. It is contemplated that the communications network 20 includes one or more of the Internet, Intranet, a local area network, a wide area network, a wireless network, a wired network, a cellular network, a data bus, and the like. It should also be appreciated that the components of the IT infrastructure be located at a central location or at multiple remote locations.

The patient information system 12 stores patient data related to one or more patients being treated by the medical institution. The patient data include physiological data collected from one or more sensors, laboratory data, imaging data acquired by one or more imaging devices, clinical decision outputs such as early warning scores, state of the patient, and the like. The patient data may also include the patient's medical records, the patient's administrative data (patient's name and location), the patient's medical records, the patient's clinical problem(s), the patient's demographics such as weight, age, family history, co-morbidities, and the like. In a preferred embodiment, the patient data includes name, medical indication, age, gender, body mass index, systolic/diastolic blood pressure, relevant blood markers, the results of medical questionnaires about the patient's health and quality of life, and the like. Further, the patient data can be gathered automatically and/or manually. As to the latter, user input devices 22 can be employed. In some embodiments, the patient information system 12 include display devices 24 providing users a user interface within which to manually enter the patient data and/or for displaying generated patient data. In one embodiment, the patient data is stored in the patient information database 26. Examples of patient information systems include, but are not limited to, electronic medical record systems, departmental systems, and the like.

Similarly, the medical information system 14 store medical data collected from a population that is related to the patient being treated. For example, the medical information system 14 store population level medical data relating to various clinical problems of differing populations. The medical data include population level knowledge from literature, retrospective studies, clinical trials, clinical evidence on outcomes and prognosis, and the like. In one embodiment, the medical data includes historical patient data including the medical indication of patients, the interventions that were prescribed to them, their health outcomes and healthcare resource consumption which is stored in a historical patient database 28. In another embodiment, the medical data also includes intervention data relating to collected relating health outcomes and costs for patients who underwent the interventions/treatment programs of interest which is stored in an intervention database 30. Further, the medical data can be gathered automatically and/or manually. As to the latter, user input devices 32 can be employed. In some embodiments, the medical information systems 14 include display devices 34 providing users a user interface within which to manually enter the medical data and/or for displaying generated medical data. Examples of medical information systems include, but are not limited to, medical literature databases, medical trial and research databases, regional and national medical systems, and the like.

The DSS 16 stores clinical models and algorithms embodying the clinical support tools or patient decisions aids. The clinical models and algorithms typically include one or more suggested or entered diagnosis and/or treatment options/orders as a function of the patient data and the clinical problem of the patient being treated. Further, the clinical models and algorithms typically generate medical data that include one or more interventions for the various diagnosis and/or treatment options and the clinical context based on the state of the patient and the patient data. Specifically, the clinical models and/or guidelines are determined from the diagnoses and/or treatment orders for patients with specific diseases or conditions and are based on the best available evidence, i.e., based on clinical evidence acquired through scientific method and studies, such as randomized clinical trials. After receiving patient data, the DSS 16 applies the clinical model and algorithm pertinent to the clinical problem of the patient being treated and generates medical data including one or more interventions for the various diagnosis and/or treatment options. It should also be contemplated that as more patient data becomes available, the DSS 16 updates the medical data including one or more interventions for the diagnosis and/or treatment options available to the patient. The DSS 16 includes a display 36 such as a CRT display, a liquid crystal display, a light emitting diode display, to display the clinical models and algorithms and a user input device 38 such as a keyboard and a mouse, for the clinician to input and/or modify the clinical models and algorithms.

The DSS 16 also selects the most cost-effective intervention or treatment for a specific patient from multiple interventions or treatment programs applicable to that patient's clinical condition. Specifically, the DSS 16 includes a risk model engine 40 which generates a risk prediction model utilizing the medical data stored in medical information system 14 to estimate the absolute probability or risk that a certain outcome is present or will occur within a specific time period in an individual with a particular predictor profile. The risk prediction model is in the form of a logistic regression model, classification/regression tree, or Cox proportional hazards model. The risk prediction model may also be more complex, such as support vector machines, neural networks, or ensemble learners. Other applicable prediction models will be known to those skilled in the art. A cost-effectiveness analysis engine 42 retrieves detailed patient data from a specific patient from the patient information system 12 and utilizes the risk prediction model, the one or more interventions for the various diagnosis and/or treatment options, and medical data from the medical information system 14 to calculate predictions for the health and cost outcomes of the patient. Specifically, the cost-effectiveness analysis engine 42 receives predictions of health outcomes and healthcare resource consumption to estimate costs and effects of the interventions of interest specific to the specific patient. The cost-effectiveness analysis engine 42 generates displays for the estimated costs and effects specific to the patient for each intervention. Based on the result of comparing costs and effects, a recommendation for the most cost-effective intervention for the patient is displayed on the clinical interface system 18.

Specifically, the cost-effectiveness analysis engine 42 retrieves relevant patient data from the patient information system 12 that are utilized in the prediction model including name, medical indication, age, gender, body mass index, systolic/diastolic blood pressure and values of blood markers specific to the medical indication. The cost-effectiveness analysis engine 42 utilizes the prediction model to generate health outcomes such as estimated survival rates (projected or estimated) and hospital admission rates. These rates are then further used by the cost-effectiveness analysis to compute effects and costs over a given time horizon for each intervention. In the preferred embodiment, the health effects resulting from the cost-effectiveness analyses are given in quality-adjusted life years (QALYs). In this case, the expected number of life years after the intervention is adjusted for quality of life. Interventions may have an effect on the quality of life. Costs are subtracted from the gross health effects after adjusting the costs by a so-called “willingness-to-pay” value (the amount of money society is willing to pay for one unit of the effects). For each intervention, this results in a value with a unit equal to the health effects, called the “net health benefits”. The intervention with the highest net health benefits is then recommended to the user.

In another embodiment, the cost-effectiveness analysis engine 42 predicts the patient-specific health and economic outcomes (i.e., disease-related risks or hazards for a specific patient) based on results from retrospective data analysis of patient, outcome and cost data. Cost outcomes may be based on predictions of future hospitalizations. Note that hospitalization costs are the major component in the direct cost figure for chronic diseases. The health outcome related to survival may be weighted by the patient quality of life to establish quality adjusted life years. The two outcomes are then combined in a cost-effectiveness analysis to establish the most cost-effective treatment/intervention for the patient. Different intervention or treatments are compared using a quantity known as the “net health benefits”, which includes health outcomes (weighted by quality of life), expected costs, as well as the willingness-to-pay (amount willing to invest to gain one quality-adjusted life year). It should be appreciated that quality of life attributes are gathered by patient self-report (via questionnaire) or institutionalized standards. A recommendation of this treatment is provided to the user via the clinical interface system 18. The system is targeted at recommendations for care plans/service levels of telehealth programs; however the system may also be applicable to other treatment strategies.

In another embodiment, the cost-effectiveness analysis engine 42 couples the direct costs with estimated patient risks by using time integrals, correct for quality of life, and performs a cost-effectiveness analysis for each treatment strategy. This allows for comparison between treatment strategies on risk (estimated outcome), direct costs (accumulated over time, given the risks) and cost-effects, to be varied over different time horizons (30-days, one-year, life-time). A ranked list or a single recommendation of most cost-effective treatment strategies can then be provided to the decision maker (e.g., clinical specialist) or patient via the clinical interface system 18.

In another embodiment, the cost-effectiveness analysis engine 42 provides the net health benefits change as a function of the willingness-to-pay. The net health benefits of selected interventions can be visualized to the user as a function of the willingness-to-pay in the form of a chart. In one embodiment, such a chart be used to indicate if a single intervention is always dominating other interventions (i.e., the net health benefits are always higher for this intervention, regardless of the willingness-to-pay). It may also be indicated if a combination of multiple interventions is dominating other interventions over the entire range of willingness-to-pay values (e.g., intervention 1 results in the highest net health benefits for willingness-to-pay values below X, and intervention 2 results in the highest net health benefits for willingness-to-pay values above X.)

In a further embodiment, the cost-effectiveness analysis engine 42 provides a cost-effectiveness analysis for two or more interventions for a cohort of patients (patient population). In one embodiment of the invention, the net health benefits may be aggregated over multiple patients who, given their medical condition, are eligible for the same interventions. This information may be used to recommend an intervention for a population of patients.

The clinical interface system 18 enables the user to input the patient values, lifestyle regimes, willingness-to-pay, and preferences related to diagnosis and treatment from a patient's perspective which are used to select the most cost-effective intervention or treatment for a specific patient from multiple interventions or treatment programs applicable to that patient's clinical condition. In one embodiment, the clinical interface system 18 enables the user to enter specific settings for the cost-effectiveness analysis. These settings may include time horizon for the analysis, discount rates for effects and costs, and willingness-to-pay. The clinical interface system 18 also receives a quantitative evaluation and comparison of the alternative choices of treatment and pathways to the patient (not shown) being treated in the medical institution. For example, the clinical interface system 18 displays the quantitative evaluation and comparison of the choices of treatment and pathways including a comparison of alternative choices on the same measure, such as allowing the patients to adjust for lifestyle regime and preferences, outcome parameters, patient pathways, QALYs, desired probability of an overall outcome or of a specific outcome parameter, and the like including the cost effects of those choices. The clinical interface system 18 includes a display 42 such as a CRT display, a liquid crystal display, a light emitting diode display, to display the evaluation and/or comparison of choices and a user input device 44 such as a keyboard and a mouse, for the user to input the patient values and preferences and/or modify the evaluation and/or comparison. Examples of clinical interface systems 18 include, but are not limited to, a software application that could be accessed and/or displayed on a personal computer, web-based applications, tablets, mobile devices, cellular phones, and the like.

The components of the IT infrastructure 10 suitably include processors 46 executing computer executable instructions embodying the foregoing functionality, where the computer executable instructions are stored on memories 48 associated with the processors 46. It is, however, contemplated that at least some of the foregoing functionality can be implemented in hardware without the use of processors. For example, analog circuitry can be employed. Further, the components of the IT infrastructure 10 include communication units 50 providing the processors 46 an interface from which to communicate over the communications network 20. Even more, although the foregoing components of the IT infrastructure 10 were discretely described, it is to be appreciated that the components can be combined.

With reference to FIG. 2, a block diagram of a patient-specific cost-effectiveness analysis application 200 is illustrated. The patient-specific cost-effectiveness analysis application 200 includes a graphical user interface (GUI) 202 where relevant medical details from a patient can be retrieved from a transactional patient database 204. A risk model engine 206 queries (on a regular basis) a historical patient database 208 and generates parameters for a prediction model 210 of the health outcomes and healthcare resource consumption. The historical patient database 208 keeps records of the medical indication of patients, the interventions that were prescribed to them, their health outcomes and healthcare resource consumption. The prediction model 210 receives the patient medical details (as retrieved in the GUI) and calculates predictions for the health outcomes (e.g., survival rate) and healthcare resource consumption (e.g., hospital admission rate). The parameters for the prediction model 210 are obtained from a prediction model engine external to the patient-specific cost-effectiveness analysis application. A module for cost-effectiveness analysis 212 receives predictions of health outcomes and healthcare resource consumption from the prediction model to estimate costs and effects of several interventions. These interventions and their associated costs can be retrieved from an external database 214 based on the given medical indication of the patient. The costs and effects for each intervention are then displayed to the user in the GUI 202. A recommendation for the most cost-effective intervention is also given.

With reference to FIG. 3, an exemplary embodiment of a screenshot of a cost-effectiveness web-based application 300 is illustrated. The application 300 includes a patient details window 302 which enables the user to input or retrieve patient data. The patient details window 302 includes the patient name 304, age 306, gender 308, body mass index 310, systolic/diastolic blood pressure 312, relevant blood markers 314, and the patient's health and quality of life 316. The application 300 also includes a clinical setting window 318 which provides the clinical settings for one or more interventions 320 selected for the patient based on the patient data. The clinical setting window 318 includes a time span input 322, the hazard rates 324 of the one or more interventions including morality 326 and hospitalization 328, and the discount rate effect 330. The application 300 also includes a cost settings window 332 which provides the cost associated with the one or more interventions 320. The cost setting window 332 includes the annual strategy cost 334 for each intervention, the hospitalization cost 336, the willingness to pay 338, and the discount rate cost 340. A recommended details window 342 is also included in the application 300 which provide analysis of each of the interventions 320. The recommended details window 342 includes the survival rate 344, effect (QALYs) 346, total cost 348, net health benefits 350, and annual hospital costs 352 for each intervention. The application 300 also includes the recommended action 354 provide the most cost-effective strategy.

With reference to FIG. 4, a flowchart diagram 400 for performing a cost-effectiveness analysis is illustrated. The method 400 is executable by one or more processors and the like as illustrated in FIG. 2. In a step 402, patient medical information is retrieved from the transactional database. In a step 404, one or more interventions for which to perform the analysis are selected based on the medical indication of the patient. In a step 406, the medical information of the patient is used by the prediction model to estimate future health outcomes, healthcare costs, and costs of each intervention. In a step 408, the net health benefit for each intervention is displayed to the user. Specifically, based on the costs and outcomes, a cost-effectiveness analysis is performed to compute so-called “net health benefits”, which is the accumulated health effect of the intervention over a given time span, from which the total accumulated costs are subtracted. Prior to subtraction, the costs are normalized (divided) by the “willingness-to-pay”, the amount of money that society is willing to pay for one (quality-adjusted) life year. In a step 410, a most cost-effective intervention is recommended to the user.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), personal data assistant (PDA), cellular smartphones, mobile watches, computing glass, and similar body worn, implanted or carried mobile gear; a user input device includes one or more of a mouse, a keyboard, a touch screen display, one or more buttons, one or more switches, one or more toggles, and the like; and a display device includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for performing patient-specific cost-effectiveness analysis for medical interventions, the method comprising:
retrieving patient data associated with a patient;
selecting one or more interventions based on the patient data;
estimating at least one of health effects, resource consumption, and intervention costs for each of the selected interventions;
calculating the net health benefit for each intervention; and
displaying the net health benefit for each intervention.

2. The method according to claim 1, further including:
recommending the most cost-effective intervention to the patient.

3. The method according claim 1, further including:
comparing the net health benefit for each intervention over a time horizon; and
displaying the comparison of the net health benefits.

4. The method according to claim 1, further including:
visualizing the net health benefits as a function of willingness-to-pay, there by indicating interventions or combinations of interventions that results in the highest net health benefit over a range of willingness-to-pay values.

5. The method according to claim 1, wherein net health benefits are aggregated over all patients in a cohort of patients.

6. The method according to claim 1, wherein calculation the net health benefit further includes:
subtracting the accumulated health effect of the intervention over a given time span from the total accumulation of costs.

7. The method according to claim 1, further including:
utilizing a risk prediction model to determine the prediction of health effects and resource consumption from the patient data.

8. The method according to claim 7, wherein estimation at least one of health effects, resource consumption, and intervention costs for each of the selected interventions further includes:
retrieving historical patient data including health outcomes and costs for patients who underwent each intervention;
generating the risk prediction model from the historical patient data.

9. The method according to claim 1, wherein the patient data includes at least one of the patient's name, age, gender, body mass index, systolic/diastolic blood pressure, relevant blood markers, and the patient's health and quality of life.

10. A system for performing patient-specific cost-effectiveness analysis for medical interventions, the system comprising:
one or more processor programmed to:
retrieve patient data associated with a patient;
select one or more interventions based on the patient data;
estimate at least one of health effects, resource consumption, and intervention costs for each of the selected interventions;
calculate the net health benefit for each intervention; and
display the net health benefit for each intervention.

11. The system according to claim 10, wherein the one or more processor are further programmed to:
recommend the most cost-effective intervention to the patient.

12. The system according to claim 10, wherein the one or more processor are further programmed to:
compare the net health benefit for each intervention over a time horizon; and
display the comparison of the net health benefits.

13. The system according to claim 10, wherein calculation the net health benefit further includes:
subtracting the accumulated health effect of the intervention over a given time span from the total accumulation of costs.

14. The system according to claim 10, wherein the one or more processor are programmed to:
utilize a risk prediction model to determine the prediction of health effects and resource consumption from the patient data.

15. The system according to claim 14, wherein estimation at least one of health effects, resource consumption, and intervention costs for each of the selected interventions further includes:
retrieving historical patient data including health outcomes and costs for patients who underwent each intervention;
generating the risk prediction model from the historical patient data.

16. A system for performing patient-specific cost-effectiveness analysis for medical interventions, the system comprising:
a patient information system which stores patient data associated with a patient;
a decision support system which selects one or more interventions based on the patient data, estimates at least one of health effects, resource consumption, and intervention costs for each of the selected interventions, and calculate the net health benefit for each intervention; and
an interface system which displays the net health benefit for each intervention.

17. The system according to claim 16, wherein decision support system recommends the most cost-effective intervention to the patient.

18. The system according to claim 16, wherein the decision support system compares the net health benefit for each intervention over a time horizon and the interface system displays the comparison of the net health benefits.

19. The system according to claim 16, wherein calculation the net health benefit further includes:
subtracting the accumulated health effect of the intervention over a given time span from the total accumulation of costs.

20. The system according to claim 16, wherein decision support system utilizes a risk prediction model to determine the prediction of health effects and resource consumption from the patient data.

21. The system according to claim 20, wherein estimation at least one of health effects, resource consumption, and intervention costs for each of the selected interventions further includes:
retrieving historical patient data including health outcomes and costs for patients who underwent each intervention;
generating the risk prediction model from the historical patient data.

22. The system according to claim 16, wherein the patient data includes at least one of the patient's name, age, gender, body mass index, systolic/diastolic blood pressure, relevant blood markers, and the patient's health and quality of life.
